(19) United States
(12) Patent Application Publication
(10) Pub. No.: US 2001/0040071 A1
(43) Pub. Date: Nov. 15, 2001

(54) ELEVATOR WITH GOVERNOR

(75) Inventor: HIROTADA SASAKI, TOKYO (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Kabushiki Kaisha Toshiba

(21) Appl. No.: 09/390,302

(22) Filed: Sep. 3, 1999

(30) Foreign Application Priority Data
Sep. 3, 1998 (JP) H10-249872

(51) Int. Cl. B66B 5/04

(52) U.S. Cl. 187/373

(57) ABSTRACT

An elevator including a movable unit, such as a passenger cage or a counterweight balancing the passenger cage, configured to ascend and descend in an elevator shaft by operation of a drive unit, and a governor configured to detect the speed of the movable unit to effect an emergency stop of the movable unit, the governor being fixed by means of a support member to a guide rail extending along the elevator shaft.

### CROSS REFERENCE TO RELATED APPLICATION

This application claims benefit of priority to Japanese Patent Application No. JP-10-249872 filed Sep. 3, 1998, the entire disclosure of which is incorporated by reference herein.

### BACKGROUND OF THE INVENTION

1. Field of the Invention

The present invention relates to an elevator with a governor for automatically controlling the speed of a passenger cage for accommodating passengers.

2. Description of the Background

In general, elevators incorporated in high-rise buildings such as office buildings include an elevator shaft vertically extending in the building, a pair of guide rails in the shaft, a cage capable of ascending and descending between the guide rails with the aid of a cage frame, a cable for suspending the cage, and a hoisting machine for driving the cable to move the cage up and down.

One such elevator is provided with an emergency stop device for safely stopping the cage in case of trouble. The emergency stop device includes a governor for detecting the moving speed of the cage and an emergency stop mechanism adapted to stop the cage when the governor detects the attainment of a moving speed higher than a predetermined value. The emergency stop mechanism is provided on the cage side, and can mechanically stop the cage by means of a brake system.

The governor, which includes a sheave wound with a governor rope, can be actuated to stop the motion of the rope by the centrifugal force of whirling weights that are incorporated in the sheave. The governor rope, which usually moves at the same speed of the cage, is stopped from moving by the governor when the cage descends at a speed higher than the predetermined value. The emergency stop mechanism on the cage side is connected to the governor rope. When the rope stops, the stop mechanism is instantaneously actuated to stop the cage compulsorily.

In the conventional elevator, the hoisting machine and the governor are set in a machine room that is located above the elevator apparatus, that is, on the uppermost floor such as the rooftop of the building. The machine room requires a considerably wide space, and its installation entails high costs. Recently, therefore, an attempt has been made to develop elevators that dispense with a machine room.

In elevators that dispense with the machine room, however, spaces other than the upper part of the elevator shaft are so narrow that locating the governor, as well as the hoisting machine, is a critical problem.

### BRIEF SUMMARY OF THE INVENTION

Accordingly, one object of the present invention is to provide a novel elevator having an elevator governor optimally located in an elevator shaft.

This and other objects are achieved according to the present invention by providing a new an improved elevator including a movable unit, such as a passenger cage or a counterweight balancing the passenger cage, configured to ascend and descend in an elevator shaft by operation of a drive unit, and a governor configured to detect the speed of the movable unit to effect an emergency stop of the movable unit, the governor being fixed by means of a support member to a guide rail extending along the elevator shaft.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view for illustrating an elevator governor according to a first embodiment of the present invention;

FIGS. 2A and 2B are views for illustrating a mounting structure for the governor that constitutes a principal part of the embodiment;

FIGS. 3A and 3B are views for illustrating operation for checking the operation of an elevator;

FIGS. 4A and 4B are views for illustrating a fixing structure for a support member of the governor;

FIG. 5 is a view for illustrating the way the fixing structure facilitates the elevator operation check;

FIG. 6 is a view for illustrating a fixing structure for the support member of an alternative governor;

FIGS. 7A and 7B are views for illustrating a cover mounting structure of the governor;

FIGS. 8A and 8B are views for illustrating a cover mounting structure of an alternative governor;

FIGS. 9A and 9B are views for illustrating a mounting structure for a pulse generator;

FIG. 10 is a perspective view showing an outline of a machine-room-less elevator; and

FIG. 11 is a schematic view for illustrating emergency stop mechanisms; and

FIG. 12 is a schematic view for illustrating a emergency stop device.

### DETAILED DESCRIPTION OF THE INVENTION

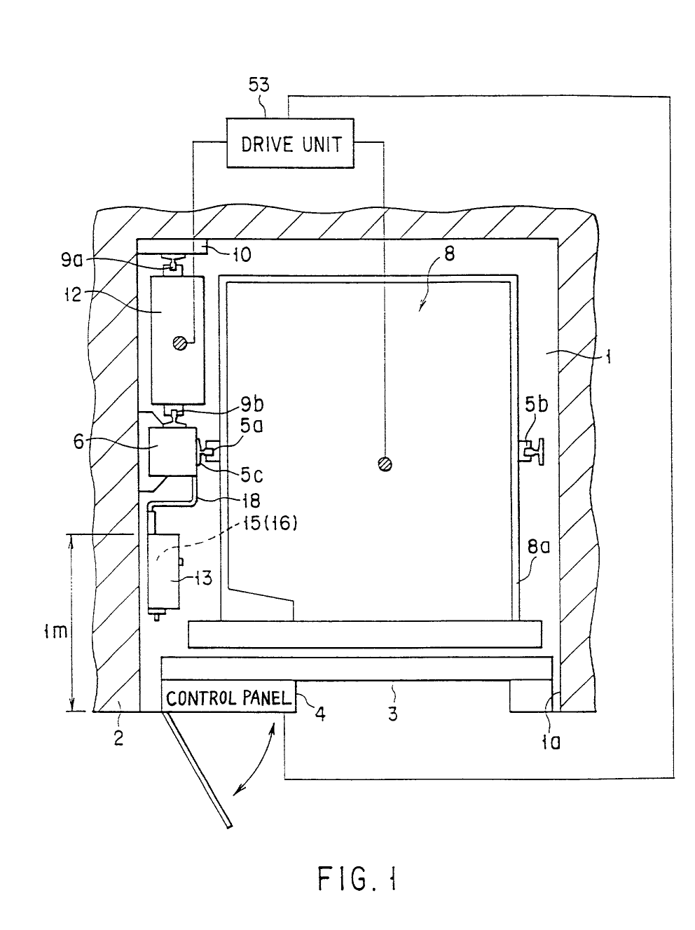

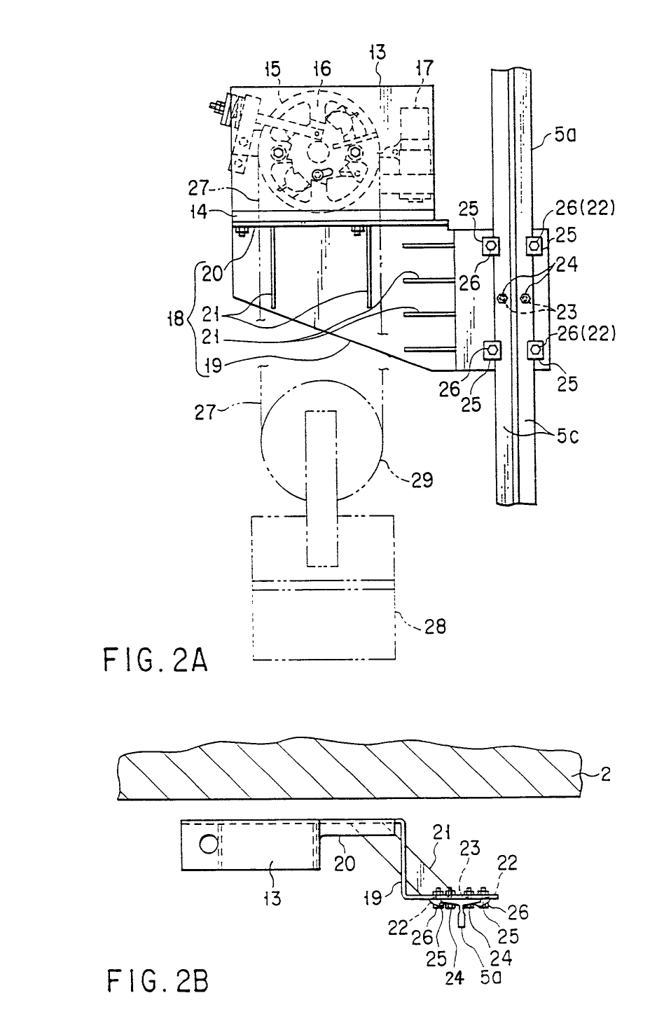

Referring now to the drawings, where like reference numerals designate the same or corresponding parts throughout the several views, and more particularly FIGS. 1 and 2, there will be described a first embodiment of the invention.

FIG. 1 is a horizontal cross-sectional view of the uppermost floor portion of an elevator incorporated in a building. Numeral 1 denotes an elevator shaft with, for example, a square cross section formed in a structure 2. The shaft 1 vertically extends, for example, from the lowermost floor of the structure 2 to the uppermost floor. As shown in FIG. 1, each floor portion of the shaft 1 is provided with an opening 1a, which communicates with an elevator hall. The opening 1 a is provided with an automatic door apparatus 3. In the opening of the uppermost floor, a control panel 4 is stored in a door box portion of the door apparatus 3.

A pair of vertically extending cage guide rails 5a and 5b are respectively arranged on left- and right-hand wall surfaces of the elevator shaft 1. The rails 5a and 5b are fixed to their corresponding wall surfaces of the shaft 1 by means of first brackets 6 (only one of which is shown in FIG. 1) that individually protrude from the wall surfaces. A cage 8 is liftably supported on the rails 5a and 5b by means of a cage frame 8a, the cage 8 being integrated with the cage frame 8a as a single integrated with.

Further, a pair of vertically extending counterweight guide rails 9a and 9b are arranged on one wall surface side of the elevator shaft 1. The one counterweight guide rail 9a is fixed to a wall surface of the shaft 1 that corresponds to the back of the cage 8, and the other rail 9b to its corresponding first bracket 6. A counterweight 12 is slidably mounted on the rails 9a and 9b for up-and-down motion.

The cage 8 and the counterweight 12 are coupled to each other by means of a movable pulley structure that includes a long cable for vertical balancing.

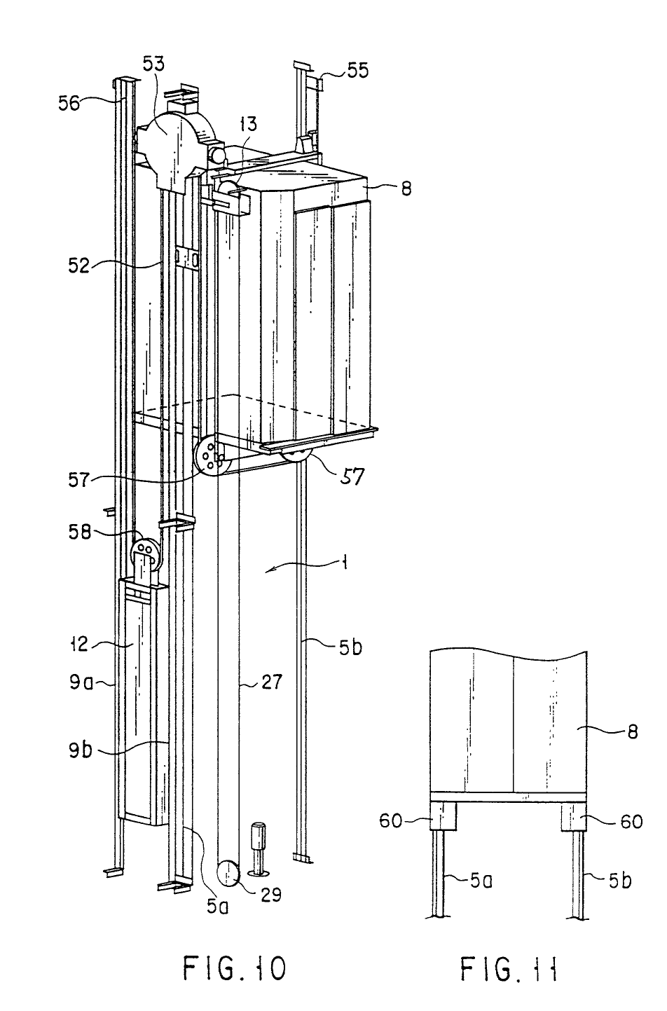

In the elevator shaft 1, as shown in FIG. 10, the cage 8 and the counterweight 12 are suspended and balanced by means of a cable 52. On the left-hand side of the upper part of the interior of the shaft 1, a drive unit 53 (a winding device or traction machine) is set in a narrow space between an inner wall of the shaft 1 and a side wall of the cage 8. The drive unit 53, which is fixed to the guide rails 5a and 9b, can wind up the cable 52, thereby relatively moving the cage 8 and the counterweight 12 up and down.

Thus, one end portion of the cable 52, which is wound up by the drive unit 53, is fixed to a cable hitch 55 that is attached to the upper end portion of the guide rail 5b, while the other end portion is fixed to a cable hitch 56 that is attached to the upper end portion of the counterweight guide rail 9a. The middle portion of the cable 52 is passed around car sheaves 57 that are attached to the lower part of the cage 8, extends through the drive unit 53, and is then passed around a counterweight sheave 58 that is attached to the upper part of the counterweight 12.

Accordingly, the cage 8 can be moved to and stopped at each floor by controlling the drive unit 53 controlled by the control panel 4.

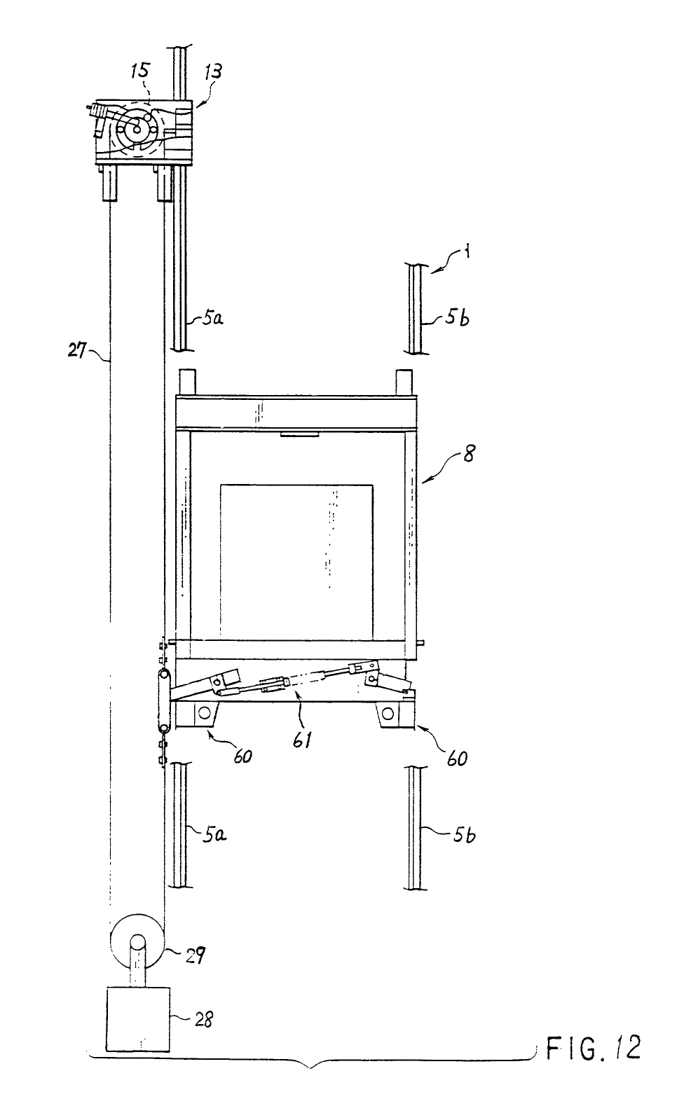

As shown in FIG. 11, emergency stop mechanisms 60 are provided on the lower end of the cage 8. The mechanisms 60 compulsorily stop the cage 8 from descending in a manner such that wedge members (not shown) are caught between the cage 8 and the guide rails 5a and 5b.

In a space portion that is defined between the rail 5a and the automatic door apparatus 3, as shown in FIG. 1, moreover, a governor 13 is fixed to the rail 5 a by means of a second bracket 18. FIGS. 2A and 2B show a layout of the governor 13.

FIG. 12 shows a emergency stop device which includes the emergency stop mechanisms 60.

The emergency stop device is composed of a governor 13 held on the guide rails 5a by means of a bracket or the like in the elevator shaft 1, an endless governor rope 27 placed around a sheave 15 of the governor 13, a tension pulley 29 having a weight 28, attached to the lower end of the governor rope 27 and capable of applying a predetermined tension to the rope 27. The emergency stop device further has a link mechanism 61, which is attached to the lower end portion of the cage 8 and connects the rope 27.

As the cage 8 ascends or descends, the rope 27, which is connected to the cage 8 by means of the link mechanism 61, moves at the same speed as the cage 8, whereupon the sheave 15 of the governor 13 rotates. If the cage 8 descends at an extraordinary speed from any cause, the governor 13 is actuated to restrain the movement of the rope 27.

Thereupon, one end portion of the link mechanism 61 is pulled up relatively, so that the emergency stop mechanisms 60 are actuated for example, as described in U.S. Pat. No. 5,377,786.

As shown in FIG. 2A, the governor 13 has a frame 14, on which a sheave 15, a centrifugal rope binding mechanism 16, and a limit switch 17 for releasing the power supply are combined as a unit.

The governor 13 is fixed to the left-hand cage guide rail 5a by means of a second bracket 18 composed of a steel plate that combines a bended vertical plate 19, an L-shaped horizontal plate 20 on one end side of an upper part of the vertical plate 19, and various reinforcing plates 21. The frame 14 is fixed to the top surface of the horizontal plate 20, whereby the governor 13 is mounted on the second bracket 18.

Pairs of through holes 22 are formed in the upper and lower portions of the horizontal plate 20. The holes 22 are arranged at a space that is equivalent to the width of a fixed seat 5c of the guide rail 5a. Midway between the upper and lower portions of the plate 20, moreover, a pair of through holes 23 centered in the seat 5c of the rail 5a.

Bolts 24,26 penetrate through holes 22 and 23, six in total, such that the middle portion of the plate 19 is fixed to the guide rail 5a by means of bolts 24, individually, and the upper and lower portions of the plate 19 are clamped to the guide rail 5a by means of their corresponding clips 25 and bolts 26.

Thus, the second bracket 18 is positioned with respect to the guide rail 5a by means of bolts 24 introduced through the through holes 23 and fixed firmly by means the bolts 26 introduced through the remaining holes 22 and secured by clips 25.

In this arrangement, the governor 13 is set near the hall door apparatus 3 on the uppermost floor, and more specifically, by the wall of the elevator shaft 1 behind the door box within 1 meter of the door apparatus 3.

An endless governor rope 27, which is connected to the emergency stop mechanisms 60 of the cage 8, is passed around the sheave 15 of the governor 13. As indicated by two-dot chain line in FIG. 2A, moreover, a tensioning pulley 29 having a weight 28 is suspended by the lower part of the rope 27, whereby the rope 27 is tensioned.

The governor 13 serves to detect the moving speed of the cage 8. If the moving speed of the cage 8 exceeds a predetermined value due to snapping of the cable 52 or the like, the governor 13 actuates the centrifugal rope binding mechanism 16. Thereupon, the governor rope 27 is bound to activate the emergency stop mechanisms 60 of the cage 8.

A first advantage of the present invention thus arranged is that the governor 13 does not require any machine room because it is fixed to the cage guide rail 5a for guiding the cage 8 in the elevator shaft 1. The governor 13 can be located in an optimum position in consideration of the size of the shaft 1, the relative position of the cage 8, etc. Since the same support member (second bracket) 18 can be used to support the governor 13 without regard to the configuration of the building structure 2, moreover, the cost performance can be improved.

Secondly, only specific portions of the support member 18 for supporting the governor 13 are fixed by means of the bolts 24, and the other portions by means of the rail clips 25. In fixing the support member 18, therefore, it is necessary only that the support member 18 be led to its optimum position on the cage guide rail 5a with the clips 25 as guides and then fixedly positioned by means of the bolts 24 that penetrate the fixed seat 5c of the rail 5a. This operation is very easy. Further, the positioning bolts 24 need not be fixed in many places. They may be fixed in two places, as shown in FIG. 2A, or in one place. Thus, only one bolt can be used to affix the support member 11, that is, the fixing operation can be carried out efficiently. Since fixing the support member 18 does not require many through holes, moreover, the strength of the cage guide rail 5a can be restrained from lowering.

Thirdly, according to this arrangement, the governor 13 is located near the hall door apparatus 3, so that the governor rope 27 in a bound state can be released by a maintenance man who leans out of the hall door and unlock the governor 13 behind the door box by means of a tool (not shown). This releasing operation is easy. It is to be understood that the governor 13 may be unlocked through the interior of the opened door box.

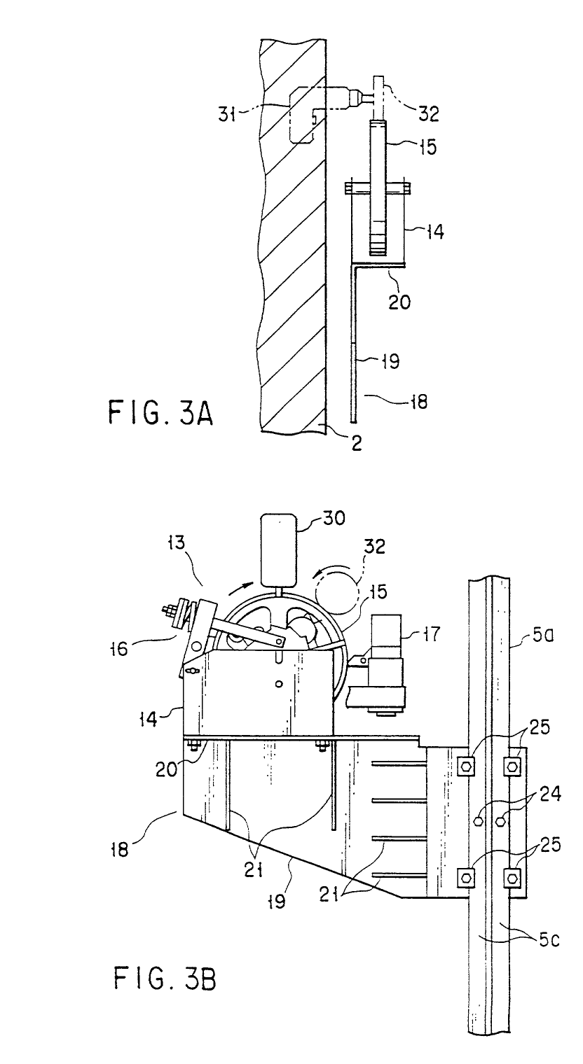

Referring now to FIGS. 3A to 5B, there will be described an arrangement for the inspection of the governor.

The elevator must be checked to see if the governor 13 operates normally. More specifically, in this operation check, the maintenance man checks the governor 13 to assure that at a specific speed the emergency stop mechanisms are activated.

In starting this operation check, a tachometer 30 is first set on the sheave 15 without the governor rope 27 thereon, as shown in FIG. 3B. Then, the maintenance man holds a roller 32, which is set on the distal end of a power drill 31 (shown in FIG. 3A), against the outer peripheral portion of the sheave 15, thereby rotating the sheave 15. When the rotational speed of the sheave 15 reaches an emergency stop speed for the cage 8, whether or not the centrifugal rope binding mechanism 16 operates is checked.

The sheave 15 is rotated in one specific direction for consideration of the check of the operation for the descent of the cage 8. The power drill 31 must also be rotated in one specific direction.

In the case where the governor 13 is located near the wall surface of the elevator shaft 1. as shown in FIG. 1, therefore, the power drill 31 sometimes must be held in the position indicated by two-dot chain line in FIG. 3A. In this case, the wall surface of the shaft 1 may possibly prevent the drill 31 from being held in position.

Thus, according to the present embodiment, there is provided an arrangement that facilitates the hold of the power drill 31.

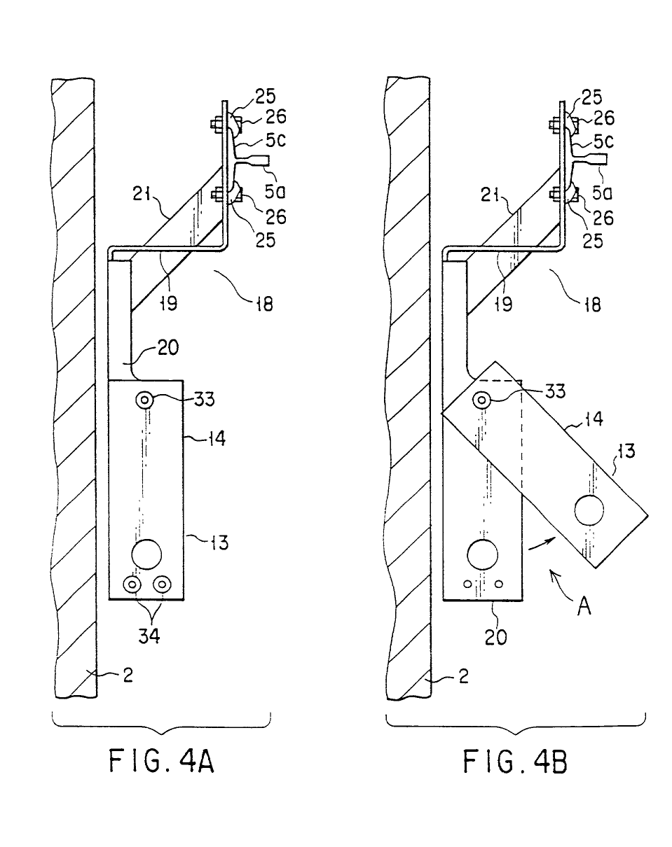

FIGS. 4A and 4B show the arrangement according to this embodiment. These drawings, which correspond to the drawing of FIG. 2B, are top views showing the relative positions of the frame 14 (see FIG. 2A) of the governor 13 and the support member 18 supporting the frame 14. As shown in FIG. 2A, the frame 14 serves to hold the governor 13.

According to this embodiment, as shown in FIG. 4B, the frame 14 for holding the governor 13 is designed to be pivotable around pivot point 33 on the side of the guide rail 5a. More specifically, the end portions of the frame 14 are fixed to the horizontal plate 20 of the support member 18 by means of bolts 33 and 34, respectively. Thus, the frame 14 can be rocked away from the wall surface of the elevator shaft 1 by removing the bolts 34 on the outer end side.

Thereupon, a space A is created between the governor 13 and the wall surface of the elevator shaft 1, as shown in FIG. 4B. The power drill 31 can be inserted and held in the space A.

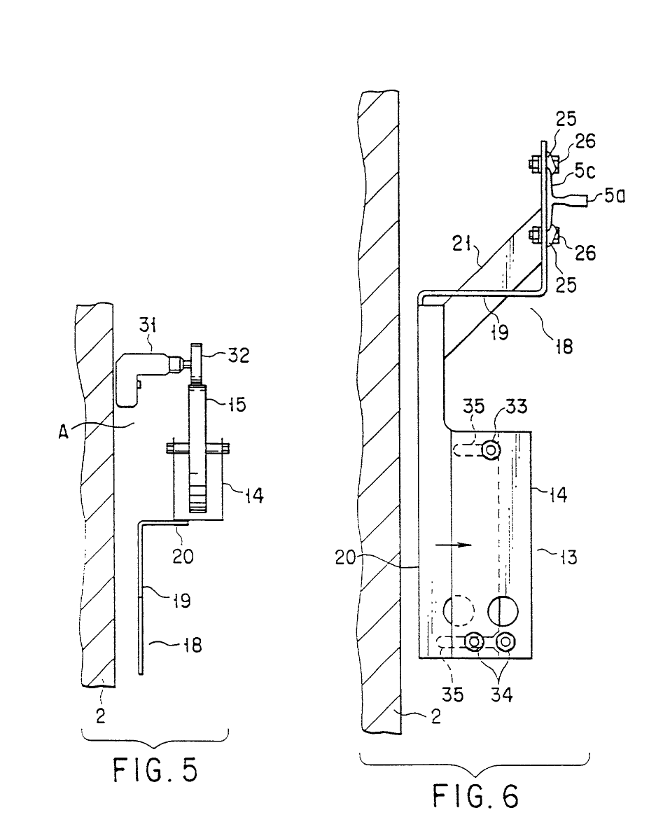

In another embodiment, the governor 13 may also have a slidable structure, as shown in FIG. 6, in place of the pivotable structure. According to this embodiment, a bolt slot 35 is formed extending toward the inner part of the elevator shaft 1 in the horizontal plate 20 and is penetrated by the bolts 33 and 34. In this case, the whole governor 13 can be slid toward the inner part of the shaft 1 after the bolts 33 and 34 are loosened. By doing this, the governor 13 can be moved away from the wall surface of the shaft 1 to create a space A between the governor 13 and the wall surface of the elevator shaft 1, as shown in FIG. 5. Furthermore, instead of forming the slot in the plate 20, a slot may be formed as a bolt hole in the frame 14.

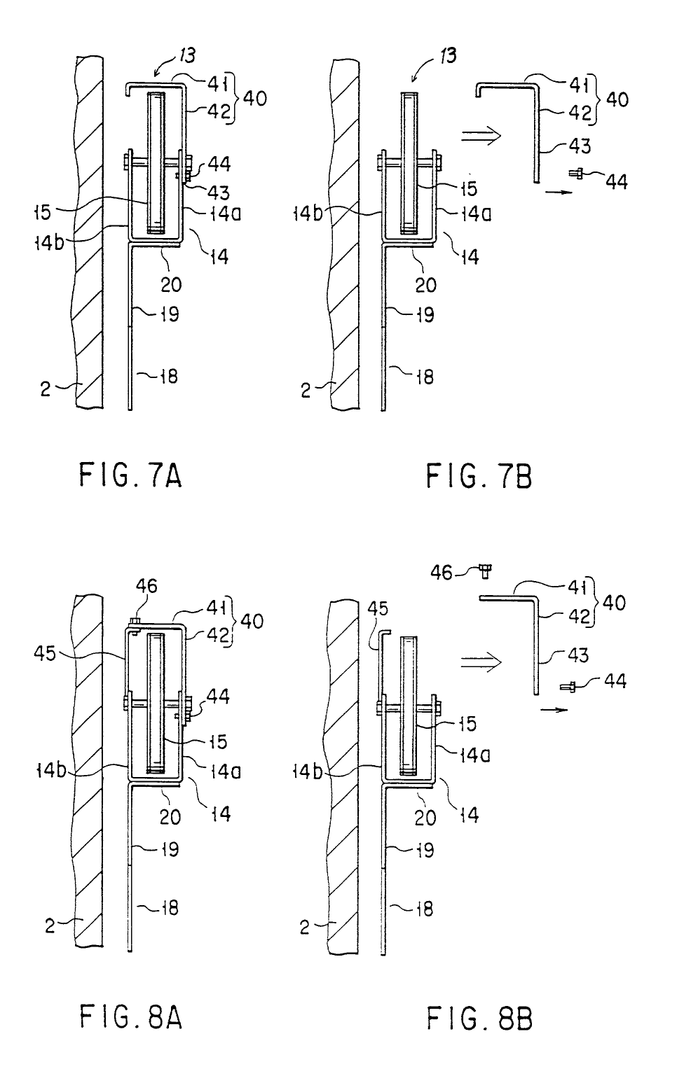

FIGS. 7A and 7B show a cover structure for the sheave 15 of the governor 13.

In an elevator having the governor in its shaft, the governor is located near the maintenance man who gets on the top side of the cage to carry out inspection for maintenance, so that the sheave of the governor is expected to be concealed under a cover for safety's sake.

If the cover is fixed by welding or the like, however, the governor cannot be inspected. Accordingly, the cover should be designed to be removable. In the case where the governor 13 is located by the wall of the elevator shaft 1, as shown in FIG. 1, however, the space between the wall surface of the shaft 1 and the governor 13 is so narrow that the cover requires troublesome attachment and detachment operations.

Accordingly, the cover structure of this embodiment is provided with a mounting portion in a region other than the region that faces the shaft wall and is unfit for the attachment and detachment operations.

FIGS. 7A and 7B show a specific example of this structure. These drawings are views of the governor 13 taken from the hall door side.

The frame 14 of the governor 13 is substantially in the shape of a U, open-topped, and a cover 40 is located over the frame 14 to cover the sheave 15.

The cover 40 is substantially in the shape of an inverted L, combining a horizontal plate portion 41 covering the top side of the sheave 15 and a vertical plate portion 42 covering a side face of the sheave 15 on the inner side of the elevator shaft, for example. A fixed seat 43 is formed on the distal end side of the vertical plate portion 42. The seat 43 overlaps a vertical wall 14a of the frame 14 on the inner side of the shaft. The fixed seat 43 and the vertical wall 14a are removably fastened to each other by means of a fixing member, e.g., a bolt 44 that penetrates the two, whereby the cover 40 is removably attached to the frame 14.

The cover 40, thus incorporated in the frame 14, can be easily removed despite its location beside the wall, since the bolt 44 for use as the mounting portion is located on the side of the cage 8 so that the maintenance man on the cage can work with ease.

The cover structure shown in FIGS. 7A and 7B is designed so that it opens to the wall of the elevator shaft 1. Alternatively, however, an upwardly extending plate 45 may be welded to a vertical wall 14b of the frame 14 on the shaft wall side so as to cover the open wall-side portion, as shown in FIGS. 8A and 8B. In this case, the upper end portion of the plate 45 and the distal end of the horizontal plate portion of the cover 40 are removably fastened to each other by means of a bolt 46 so that the cover 40 is detachably attached to the frame 14.

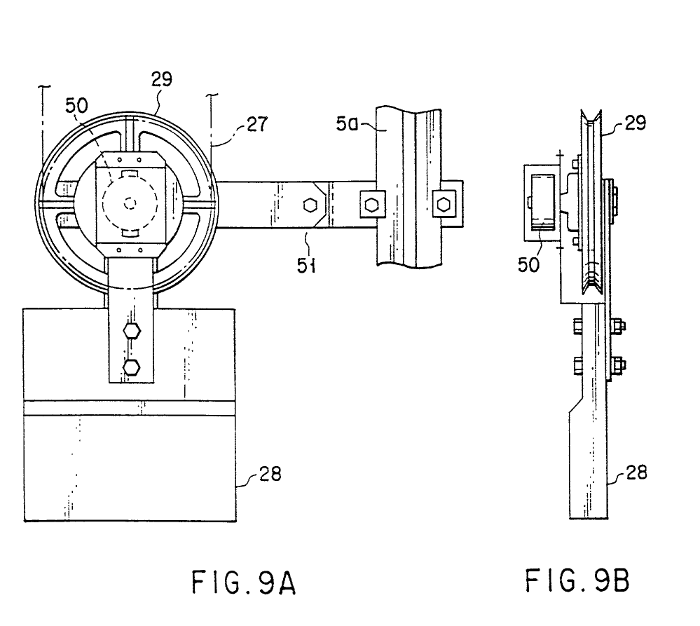

FIGS. 9A and 9B show a pulse generator located in a space in the elevator shaft 1 and used to detect stopping floors and a position of the cage 8 in the elevator shaft 1.

In general, an elevator is designed so that the actual position of the cage is detected by the position of the governor rope. To attain this, a pulse generator is attached to the governor so as to be coaxial with the sheave of the governor.

In the case where the governor is located by the wall of the elevator shaft 1, as shown in FIG. 1, the pulse generator is expected to be held in the space between the wall surface and the cage. However, this space is too narrow to hold the generator with ease therein.

According to this embodiment, therefore, the pulse generator is attached to the tensioning pulley 29 that is thinner than the governor 13 and leaves a good vacant space between the wall surface of the elevator shaft 1 and the cage 8. Thus, the pulse generator can be stored in a limited space in the elevator shaft.

More specifically, a pulse generator 50 is attached coaxially to a side portion of the tensioning pulley 29, as shown in FIGS. 9A and 9B, whereby it can be stored in the limited gap between the wall surface of the elevator shaft 1 and the cage 8. In FIG. 9A, numeral 51 denotes a regulator mechanism for restraining deflection of the pulley 29.

According to the above described embodiments, the movable unit, which is capable of ascending and descending in the elevator shaft and whose speed is detected by the governor, is the passenger cage. However, the present invention is not limited thereto, and may be also applied to a governor that detects the speed of the counterweight instead of the passenger cage. In this case, the governor may be fixed to the counterweight guide rail by means a comparable support member.

Various modifications and variations are possible in light of the above teachings. Therefore, it is to be understood that within the scope of the appended claims, the present invention may be practiced otherwise than as specifically described herein.

What is claimed as new and desired to be secured by Letters Patent of the United States is:

1. An elevator comprising:
a drive unit;
a movable unit configured to ascend and descend in an elevator shaft by operation of the drive unit;
a guide rail extending along the elevator shaft; and
a governor configured to detect the speed of the movable unit to effect an emergency stop of the movable unit; and
a support member fixing the governor to the guide rail.

2. The elevator as recited in claim 1, wherein the movable unit comprises:
a passenger cage guided in the elevator shaft by the guide rail.

3. The elevator as recited in claim 1, wherein:
the movable unit comprises a counterweight balanced with a passenger cage and guided by the guide rail.

4. The elevator as recited in claim 1, wherein:
the drive unit is mounted on a guide rail extending along the elevator shaft.

5. The elevator as recited in claim 4, wherein:
the guide rail fitted with the drive unit is a guide rail for guiding the cage.

6. The elevator as recited in claim 4, wherein:
the guide rail fitted with the drive unit is a guide rail for guiding a counterweight balanced with the cage.

7. The elevator as recited in claim 1, wherein:
the support member includes a plurality of fixing spots fixed to the guide rail, including at least one fixing spot fixed to the guide rail by means of a pin-shaped member penetrating the guide rail, and at least one further fixing spot fixed to the guide rail by means of a clip member.

8. The elevator as recited in claim 1, wherein:
the governor is movably held on the support member for movement away from a wall surface of the elevator shaft.

9. The elevator as recited in claim 1, wherein:
the governor is pivotably held on the support member for pivotal movement away from a wall surface of the elevator shaft.

10. The elevator as recited in claim 1, wherein:
the governor is slidably held on the support member for sliding movement away from a wall surface of the elevator shaft.

11. The elevator as recited in claim 1, further comprising:
a cover removably attached to a side of the governor facing an interior of the elevator shaft.

12. The elevator as recited in claim 1, wherein:
the elevator comprises an elevator door; and
the governor is located nearer to the elevator door than to the guide.

13. The elevator as recited in claim 1, wherein the governor comprises:
an endless rope synchronously moving with the movable unit;
a tensioning pulley configured to produce tensioning of the endless rope; and
a pulse generator fitted on the tensioning pulley and configured to detect a floor for a stop.
